(19) United States
(12) Patent Application Publication
(10) Pub. No.: US 2026/0071460 A1
(43) Pub. Date: Mar. 12, 2026

(54) Temporary Fence Panel Coupler

(71) Applicants: John Pitt, Glasgow (GB); HellermannTyton Limited, Manchester (GB)

(72) Inventors: John Pitt, Glasgow (GB); Adam Gale, Oldham (GB); Steve Blanks, Cheshire (GB)

(73) Assignee: HellermannTyton Limited, Manchester (GB)

(21) Appl. No.: 19/104,213

(22) PCT Filed: Aug. 23, 2023
(86) PCT No.: PCT/GB2023/052197

§ 371 Date: Feb. 15, 2025

(30) Foreign Application Priority Data
Aug. 24, 2022 (GB) 2212325.1

(51) Int. Cl. E04H 17/14; F16B 7/04

(52) U.S. Cl. CPC E04H 17/1473; F16B 7/0433

(57) ABSTRACT

A fence panel coupler includes a first coupling member having first and second connector portions, each having an opening for receiving first fence post and a second fence posts. A second coupling member includes third and fourth connector portions, also with openings for receiving the first and second fence posts. The first and second coupling members are applied to the fence posts in an insertion first direction and moved together to a closed configuration in a second direction perpendicular to the insertion direction. Integral locking elements lock the first and second coupling members together in the closed configuration. The connector portions cooperate to surround the fence posts and prevent removal of the fence post coupler from the fence posts.

### FIELD OF INVENTION

The present disclosure relates to a temporary fence panel coupler, and in particular to a two part fence coupler that requires no additional fasteners.

### BACKGROUND

Temporary fence panels are commonly used for safety and security purposes to form non-permanent barriers about areas such as construction sites and outdoor events. Temporary, movable fence panels for such applications typically consist of an outer frame formed from one or more tubular metal poles. Each fence panel includes at least two vertical posts and a mesh panel supported within the outer frame. The fence panels are sized such that they can be manually moved into position, and a series of fence panels are assembled to form a desired barrier.

A weighted base or foot is associated with adjacent pairs of fence panels that includes sockets for receiving and supporting a post of each fence panel. The weighted base anchors the fence panels and provides stability. Fence post couplings are also used to fix adjacent vertical fence posts together, to provide a more secure connection and prevent the fence from being readily dissembled. The outer frame is generally formed as a continuous loop, and the inner mesh panel is permanently connected to the frame. It is therefore not possible to slide annular connectors onto the fence posts. Instead, fence post couplers generally comprise a clamping arrangement including rigid metal clamping plates located on opposing sides of the fence posts and secured together with a threaded faster. A bolt extends through the central holes in the clamping plates in the gap between the fence posts and is secured with a corresponding nut.

To apply the coupler, the clamping plates must be held in position on either side of the fence posts while the threaded faster is fitted and tightened. The location of the fastener means the tightening tool must be operated within the confined space between the fence posts. Holding the clamping plates in position and fastening them in this way is a difficult manual task, and often requires two people. The multiple couple components must be acquired and distributed prior to assembly, and are easily dropped or lost during assembly, particularly in adverse weather conditions. In addition, threaded nut and bolt fasteners are prone to loosening over time and can be easily tampered with or removed using commonly available tools.

Current temporary fence panel couplers are therefore time consuming and labour intensive to apply. They are also insecure and prone to tampering, as well as being heavy and cumbersome to distribute, store and transport. Furthermore, each fence coupler must be applied using a tool, and the metal parts can rust over time.

It is therefore desirable to provide an improved temporary fence coupler which addresses the above-described problems and/or which offers improvements generally.

### SUMMARY

According to the present disclosure there is provided fence panel coupler and method of coupling fence panels as described in the accompanying claims.

In an aspect of the disclosure there is provided a fence panel coupler comprising a first coupling member including first and second connector portions each having an opening for receiving respectively one of a first fence post and a second fence post; and a second coupling member including third and fourth connector portions each having an opening for receiving a respective one of the first and second fence posts. The first and second coupling members are movable together to an engaged, closed configuration and include integral connector elements that connect the first and second coupling members together in the closed configuration to in use prevent removal of the fence post coupler from the fence posts. The connectors hold the coupling members in engagement together in the closed configuration.

The connector elements may be locking elements that lock the first and second coupling members together in the closed configuration.

In the closed configuration, with the fence posts are received within the first and second connector portions. The first coupling member prevents release of the second coupling member in a first direction away from the fence posts and the second coupling member prevents release of the first coupling member in an opposing second direction away from the fence posts.

The term fence post is used generally herein to refer to a structural element of a fence panel, and while it may mean a cylindrical post it is not limited to such an arrangement. The two coupling members include integral locking elements and are therefore able to be secured to the fence panels without the requirement for additional fixings and without the need for tools.

The locking elements may be any element that mechanically engage to prevent vertical separation i.e. along the length of the fence posts and/or later separation i.e. perpendicular to the length of the fence posts. The locking elements may for example include arrowhead locking tabs or interlocking dovetail elements and may be arranged to prevent. The use of integral locking elements obviates the requirement for a separate fastener such as a nut and bolt fastener or cable tie to secure the coupling members. The coupler is therefore a two-part coupler with no additional parts that that may be manually fitted without requiring tools.

The closed configuration refers to the normal, unflexed configuration of the connector portions in which the size of the opening is more than zero but less than the diameter of the fence posts, such that that fence posts cannot be received into the opening for the connector portion to be inserted onto the fence post without expansion of the opening.

The connector portions may each include a resiliently flexible element reconfigurable to an expanded configuration to enlarge the respective opening of the connector portion for receiving the respective fence post. Specifically, first and second connector portions of the first coupling member and the third and fourth connector portions of the second coupling member each includes a resiliently flexible element. The resiliently flexible element is an integral part of the connector portions and may be any element that is moved by flexing to expand the opening of the respective connector portion.

Each connector portion includes an inner receiving section or void for receiving the fence posts and the opening permits access for the fence posts to be inserted into the receiving sections. The receiving section may be circular having a first diameter corresponding in closed configuration to the diameter of the fence post and the opening has a width. The diameter of the receiving section is greater than the width of the opening. Each receiving section has a circumference and the circumference is increased when the respective coupling portion is flexed to the expanded configuration.

The openings of the first and second connector portions are arranged for receiving respectively the first and second fence posts when the first coupling member is applied to the fence posts in a first insertion direction; the openings of the third and fourth post connector portions are arranged for receiving respectively the first and second fence posts when the second coupling member is applied to an opposing side of the fence posts in a second insertion direction that is opposite to the first insertion direction. The integral connectors are arranged to connect when the first and second coupling members are moved into engagement in a closure direction perpendicular to the first and second insertion directions. In use the insertion directions are arranged along an insertion axis that is perpendicular to the fence posts, and the closure direction is in the same direction as the longitudinal axis of the fence posts.

The connector portions of the first and second coupling members are c-shaped having opposing ends between which the opening is defined, and an inner void configured to receive a fence post. The flexible element of each connector portion comprises a flexible arm formed by a free end of the respective c-shaped connector portion. The free end is the distal end of the c-shaped connector, and the opposing proximal end is secured to an integrally formed with a body or bridge section of the coupling member.

The c-shaped connector portions connect to the fence posts in an annular snap fit arrangement, in which the connector portions flex and expand the circumference to stretch around the post, and the connector portion then snaps back to size once the fence post is received with hoop strain holding coupling member in place on the fence post. This snap fit arrangement enables each coupling member to be applied independently and to be retained on the fence posts without support while the other coupling member is applied, and the coupling members are closed together. The snap fit engagement also allows the connector to easily rotate relative to the fence post, which enables the relative orientation of fence panels to be easily adjusted to modify the fence line. Relative rotation of the coupler and the fence post also allows the coupler to function as a hinge, enabling a fence panel to be connected at one side only to operate as a gate if required.

The first and second coupling members may include retaining elements that engage with the flexible arms of the corresponding coupling member when in the closed configuration to restrain the flexible arms and prevent outward flexing. The retaining elements may for example comprise raised wall sections or tabs that locate outwardly of the flexible elements or locking tabs that engage with corresponding slots in the distal ends of the flexible arms.

The coupling members may be able to slide along the fence posts when the fence posts are received within the connector portions of the coupling members, the first and second coupling members are slidable towards each other along the fence posts to the closed configuration.

The flexible arm of each connector portion may be reconfigurable between a clamping configuration in which the opening has a first width and the expanded configuration in which the opening has a second width and is biased to the clamping configuration. The clamping configuration is the normal position to which the flexible arm is biased.

The flexible arm of each connector portion moves to the expanded configuration when the opening of the connector portion is urged against a fence post. The connector portion has chamfered lead edges that interact with the curved surface of the fence posts to create a lateral wedging force that expands the opening. Each flexible finger is configured to be biased against the corresponding fence post when the fence post is received within the connector portion. The degree of biasing force is determined in part by the normal, non-expanded inner diameter of the receiving section relative to the diameter of the fence posts. The biasing force is sufficient to cause the coupling member to grip to the fence posts in a self-supporting manner, while also allowing a person to manually slide the coupling member along fence posts.

The first and second connector portions of the first coupling member are interconnected by a first bridge section, and the third and fourth connector portions of the second coupling member are interconnected by a second bridge section. The locking elements of the first and second coupling members are located on the first and second bridge sections respectively.

The coupling members may be a pair of universal identical components. Each coupling member has an outer surface, an inner surface, a front edge and a rear edge. The couplers are arranged in use in a spaced location along the fence posts with their inner surfaces facing each other in the closure axis and the openings facing in opposing directions in the insertion axis. The rear edge of the first closure member is aligned with the front edge of the second closure member and the front edge of the first closure member is aligned with the rear edge of the second closure member i.e. the coupling members are rotated 180° relative to each other along their longitudinal axis.

Each coupling member is a single piece integrally moulded component. The coupling members may be formed of a thermoplastic.

The first coupling member may include first and second closure elements and the second coupling member includes third and fourth closure elements, the first and second closure elements being arranged to close the openings of the third and fourth coupling portions and the third and fourth closure elements are arranged to close the openings of the first and second connector portions when the first and second coupling members are connected in the closed configuration. The closure elements project inwardly (i.e. away from the inner surface) of the connector portions and are located diametrically opposite the openings such that they fit within the corresponding openings of the opposing coupling member in the closed configuration. The closure elements span the opening to create a continual annular connection around the fence post. The coupling members thereby combine to encircle both fence posts in a handcuff arrangement.

The first and second closure members may be integrally formed parts of the first and second connector portions and the third and fourth closure members are integrally formed parts of the third and fourth connector portions. In the closed configuration the first and third connector portions combine to form a first annular connector that in use surrounds the first fence post and the second and fourth connector portions combine to form a second annular connector that in use surrounds the second fence post.

The locking elements may be arrowhead type connectors with each extending from an inner surface of the respective coupling members and each comprising a flexible shaft and a tapered locking head. The flexible shaft may be a stem, upstanding wall or any other upright flexible support element. When the coupling members are moved to the closed configuration the locking elements flex away from each other due to the wedging engagement of the ramped surfaces of the locking heads and close to an interlocked configuration when the locking heads move past each other in which the locking surfaces of the locking elements abut each other to prevent release.

The first and second coupling members may be moved to the closed configuration along a closure axis that in use is parallel with the longitudinal axis of the fence posts, and the coupling members are inserted onto the fence posts along an insertion axis that is perpendicular to the closure axis, and the locking elements interlock to prevent separation in the closure axis.

The first and second couplers may include secondary interlocking elements that interlock when the coupling members are in the closed configuration and are arranged to prevent separation along the insertion axis. The secondary locking elements may comprise dovetail formations formed on the inner surfaces of the coupling members.

The coupling members include side walls that cooperate to create a continuous enclosure in the closed configuration. The integral locking elements are enclosed within the fence panel coupler in the closed configuration and cannot be manually accessed. At least one of the coupling members includes an aperture arranged for receiving a tool to release the locking elements and enable separation of the coupling members.

In another aspect of the present disclosure there is provided a fence panel coupling system comprising a fence panel coupler as described above and a release tool configured to be inserted into an aperture of the coupling member. The locking elements are arranged relative to the aperture such that they are engaged by the release tool on insertion, which causes the locking elements to separate. In this way, the coupler may only be released by the use of a dedicated tool, preventing unauthorised removal.

The release tool may include a shaft or stem having a longitudinal axis and first and second lateral dimensions (e.g. width and thickness) perpendicular to the longitudinal axis, the second lateral dimension being greater than the first lateral dimension. The stem is inserted in a first orientation in which the locking elements are separated by the first lateral dimension and the stem being rotatable to a second orientation in which the locking elements are separated by the second lateral dimension. The stem is rotated using the handle. The aperture is shaped to only permit insertion of the stem in the first orientation.

The stem may include a locking tab that is received through the aperture when the stem is inserted in the first orientation and engage with one of the coupling members to prevent release of the stem from the aperture when the stem is in the second orientation, enabling the release tool to lift the coupling member to separate the fence coupler. The aperture is shaped to only permit insertion of the stem in the first orientation, and to prevent release of the stem in the second orientation due to interference with locking element.

The tool is inserted into an aperture (key hole) in one of the coupling members. The coupling member includes a ramped element located on its inner surface proximate the aperture that is arranged to be engaged by the locking element as the stem is rotated to the second configuration, causing the stem to move axially further into the coupler and apply an axial separation axial force to the locking elements. As both coupling members are identical both have apertures and either may be selected such that the coupler may be unlocked from either side.

In another aspect of the present disclosure there is provided a method of coupling fence panels comprising: providing a fence coupler as described above; connecting the first coupling member onto a first side of first and second fence posts in a first insertion direction; connecting the second coupling member onto an opposing second side of the first and second fence posts in an opposing second insertion direction at a spaced location from the first coupling member relative to the length of the fence posts; and moving the first and second coupling members to a closed configuration by sliding at least one of the coupling members in a closure direction along the first and second fence posts towards the other coupling member.

The method may further comprise removing the fence coupler by inserting a tool into an aperture of the fence coupler and operating the tool to separate and release interlocked locking elements of the first and second coupling members, separating the first and second coupling members in a direction opposite to the closure direction when the locking elements are released, and removing the first and second coupling members form the fence posts in a direction opposite to the first and second insertion direction respectively. The method may include using the tool to lift one of the coupling members away from the other coupling member.

In another aspect of the present disclosure there is provided a fence panel coupler comprising a first coupling member including first and second connector portions each having an opening for receiving respectively one of a first fence post and a second fence post. A second coupling member includes third and fourth connector portions each having an opening for receiving a respective one of the first and second fence posts and a resiliently flexible element reconfigurable to an expanded configuration to enlarge the respective opening for receiving the respective fence post. The first and second coupling members are movable together to a closed configuration and include integral locking elements that lock the first and second coupling members together in the closed configuration to in use prevent removal of the fence post coupler from the fence posts.

In another aspect of the present disclosure there is provided a two-piece coupler comprising first and second coupling members. The coupling members are each configured to independently secure to a pair of fence posts and to connect to each other when secured to the fence posts. The first and second coupling members cooperate when connected to form a pair of annular connectors that surround the fence posts, which prevents release of both coupling members from the fence posts. The coupling members secure to the fence posts in a snap fit arrangement. The first and second coupling members preferably include integrally formed locking elements that cooperate to prevent separation of the first and second coupling members.

In another aspect of the present disclosure there is provided a fence panel coupler comprising a first and second coupling members. The first and second coupling members are connectable and combine to form a coupler having first and second annular connector parts that in use surround the posts. The first coupling member includes first and second connector portions each having an opening for receiving respectively one of a first fence post and a second fence post. The second coupling member is configured to close the first and second openings of the first coupling member to form said annular connector parts.

The second coupling member may include third and fourth connector portions each having an opening for receiving a respective one of the first and second fence posts. The first and second coupling members are connected in a closed configuration in which the first and third coupling members combine to create a first annular connector part and the second and fourth coupling members combine to form a second annular connector part.

### BRIEF DESCRIPTION OF THE DRAWINGS

The present disclosure will now be described by way of example only with reference to the following illustrative figures in which:

FIG. 1 shows a fence panel coupler according to an embodiment of the disclosure;

FIG. 2 is an enlarged view of the bridge section of FIG. 1;

FIG. 3 shows the fence panel coupler of FIG. 1 applied to fence posts in a first assembly step;

FIG. 4 shows the fence panel coupler of FIG. 1 applied to fence posts in a second assembly step;

FIG. 5 is a cross section of the coupler of FIG. 1 in the closed configuration;

FIG. 6 is a release tool according to an embodiment of the disclosure;

FIG. 7 is an enlarged view of the stem of the tool of FIG. 6;

FIG. 8 a cross section of a fence panel coupler and release tool according an embodiment of the disclosure, with the release tool in a first orientation;

FIG. 9 shows the arrangement of FIG. 5 with the release tool in a second orientation;

FIG. 10 shows a fence panel coupler according to another embodiment of the disclosure;

FIG. 11 shows a release tool according to an alternative embodiment of the disclosure;

FIG. 12 shows a cross section of a fence panel coupler and the release tool of FIG. 11, with the release tool in a first orientation;

FIG. 13 shows the arrangement of FIG. 12 with the release tool in a second orientation;

FIG. 14 shows a fence panel coupler according to an alternative embodiment of the disclosure; and

FIG. 15 shows an enlarged underside view of the connector portion of the coupling member of FIG. 14.

### DESCRIPTION OF EMBODIMENTS

The following description presents exemplary embodiments and, together with the drawings, serves to explain principles of the disclosure. The scope of the disclosure is not intended to be limited to the precise details of the embodiments or exact adherence with all method steps. Variations will be apparent to a skilled person and are deemed also to be covered by the description. Terms for features used herein should be given a broad interpretation that also encompasses equivalent functions and features. In some cases, several alternative terms (synonyms) for structural features have been provided but such terms are not intended to be exhaustive.

Descriptive terms should also be given the broadest possible interpretation; e.g. the term “comprising” as used in this specification means “consisting at least in part of” such that interpreting each statement in this specification that includes the term “comprising”, features other than that or those prefaced by the term may also be present. Related terms such as “comprise” and “comprises” are to be interpreted in the same manner. Directional terms such as “vertical”, “horizontal”, “up”, “down”, “upper” and “lower” are relative terms that may be used for convenience of explanation usually with reference to the illustrations and are not intended to be ultimately limiting if an equivalent function can be achieved with an alternative dimension and/or direction.

The description herein refers to embodiments with particular combinations of configuration steps or features. However, it is envisaged that further combinations and cross-combinations of compatible steps or features between embodiments will be possible. The description of multiple features in relation to any specific embodiment is not an indication that such features are inextricably linked, and isolated features may function independently from other features and not necessarily require implementation as a complete combination.

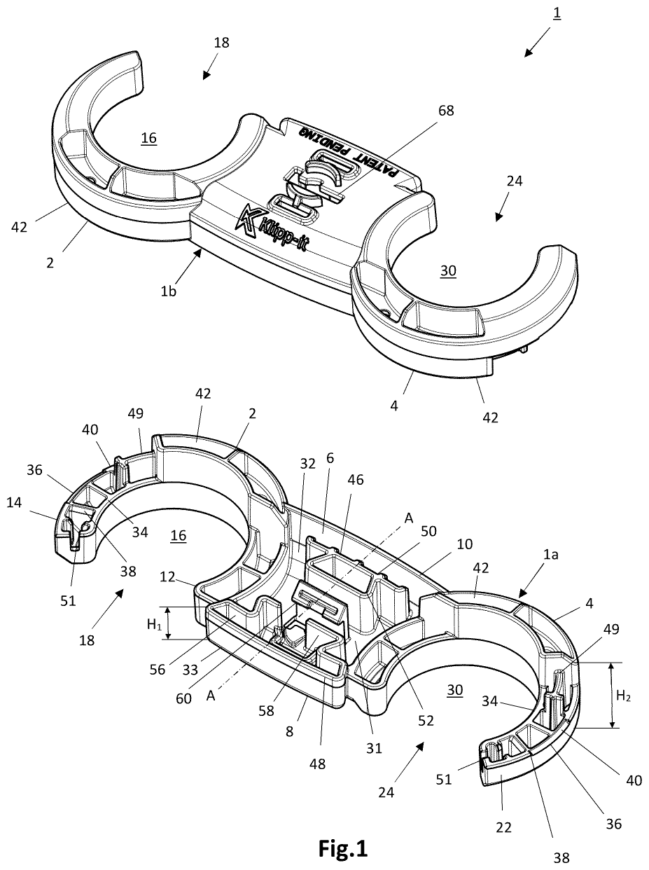

Referring to FIG. 1, a fence panel coupler assembly 1 comprises a pair of couplers formed as single piece moulded plastic components. The couplers comprise a first coupler 1a and second coupler 1b. The couplers 1a, 1b are identical components and the following description of the first coupler 1a is also applicable to the second coupler 1b. The coupler 1a comprising a first connector portion 2, a second connector portion 4, and a bridge section 6. The bridge section 6 interconnects the first and second connector portions 2, 4. The first connector 2 is integrally formed with and connected to a first side of the bridge section 6. The coupler 1a has a forward edge 8 and a rear edge 10. The coupler 1a has an insertion axis A-A extending in the front to rear direction perpendicular to the length of the coupler 1a. The first connector 2 is substantially C-shaped having a first end 12 connected to and integrally formed with the bridge section 6 and a second end 14 defining a curved flexible arm projecting from the bridge section 6. The C-shaped body of the first connector 2 is a circular inner void 16 defined therein. An opening 18 to the C-shaped first connector portion 2 is defined at the front edge 8 of the first connector portion 2 and defines the opening to the void 16. The flexible finger 14 of the first connector 2 is configured to flex outwardly away from the opposing end 12 of the connector 2 to expand the opening 18. The finger 14 is resilient and biased to return to its original configuration when any flexing force is removed. The second connector portion 4 is located on the opposing side of the bridge section 6 and has the same configuration as the first connector portion 2 in a mirrored arrangement. The second connector portion 4 has a first end 20 connected to and integrally formed with the bridge 6 and an opposing second end 22 defining a resiliently flexible finger section. The second connector portion 4 is also C-shaped and has an opening 24 defined between the first and second ends 20, 22 defined between its opposing distal ends 26, 28. The opening 24 allows access to the inner void 30 defined within the C-shaped second connector portion 4. The first and second connector portions 2, 4 are the same size, each having an inner diameter D configured to receive a fence post of circular cross section.

The connector 1 includes a base 31 including a planer outer surface 33 and an inner surface 32. A plurality of integrally moulded upstanding walls extending upwardly from the inner surface 32. The first and second connector portions 2, 4 include an upstanding inner wall 34 and outer wall 36 interconnected by a series of reinforcement ribs 38. The inner and outer walls 34, 36 and reinforcement ribs 38 extend from the inner surface to an upper edge 40 having a height H1 from the outer surface.

The first and second connector portions 2, 4 each include a curved closure element 42 located at the rear edge that is raised about the height of the inner and outer walls 34, 36. Referring to the first connector portion 2, the closure element 42 is located diametrically opposite the opening 18. The closure element 42 extends upwardly from the upper edge 40 of the inner and outer walls 34, 36 by an additional height H1 such that the rear part of the first connector portion 2 has a total height H2 that is double the height H1. The angular length of the closure element 42 is equal to the angular length of the opening 18 with the opening 18 and the closure element 42 each extending approximately 45°around the first connector portion 2. The closure elements 42 are hollow and open at their upper ends for light weighting and therefore include drainage apertures in their base to prevent them filling with rainwater in use. The closure elements 42 each include an inner end face 44 located adjacent the bridge 6 and an opposing outer end face 46. An upstanding locating tab 49 projects from the outer end face 46 of the closure members 42. The locating tab 49 is centrally located between the inner and outer walls 34, 36 and is vertically stepped below the height of the closure element 42. The distal ends of the flexible arms 14, 22 each include a corresponding slot 51 for receiving a corresponding locating tab 49 of the second coupler 1b, as described in further detail below.

The closure element 42 of the second connector portion 4 has the same shape and configuration as the closure element 42 of the first connector portion 2 in a mirrored arrangement on the opposing side of the bridge 6, with the closure element 42 corresponding in angular length to the opening 24 of the second connector portion 4. The closure elements 42 are arranged to be received within and close the openings 18, 24 of the second coupler 1b.

The bridge section 6 includes a first locating element 46 and a second locating element 48. The first and second locating elements 46, 48 are integrally moulded and project from the inner surface 32. The first and second locating elements 46, 48 are laterally aligned and spaced from each other in the insertion direction. The first locating element 46 is located towards the rear side of the bridge section 6. The first locating element 46 comprises an upstanding lateral wall 50 arranged lengthwise across the bridge section 6, perpendicular to the insertion axis A-A. A dovetail portion 52 extends forwardly from the lateral wall, tapering outwardly away from the lateral wall 50 to a wider forward edge. The dovetail portion 52 is formed by an upstanding wall and has a hollow interior. The lateral wall 50 includes vertical reinforcing ribs located on its rear side to increase the strength of the lateral wall 50. The second locating element 48 is arranged at the forward side of the bridge section 6.

The second locating element 48 is configured to receive the first locating element 46 of the second coupler 1b. The second locating element 48 comprises a perimeter wall 54 forming an enclosure having an internal shape corresponding to the shape of the first locating element 46. The enclosure includes a lateral channel section 56 corresponding in shape to the lateral wall 50 and a dovetail section 58 corresponding in shape to the dovetail portion 52. The lateral channel section 56 extends lengthwise along the bridge section 6 and the dovetail section extends rearwardly from the lateral channel section 56 towards the first locating element 46, tapering outwardly in the rearward direction. The second locating element 48 has a height H1 and the outermost wall of the lateral channel 56 forms a front wall for the bridge section. A further wall is provided at the rear edge of the bridge section to enclose the bridge section 6. The first locating element 46 has a height greater than H1 such that it extends above the upper edge 40 of the coupler 1a.

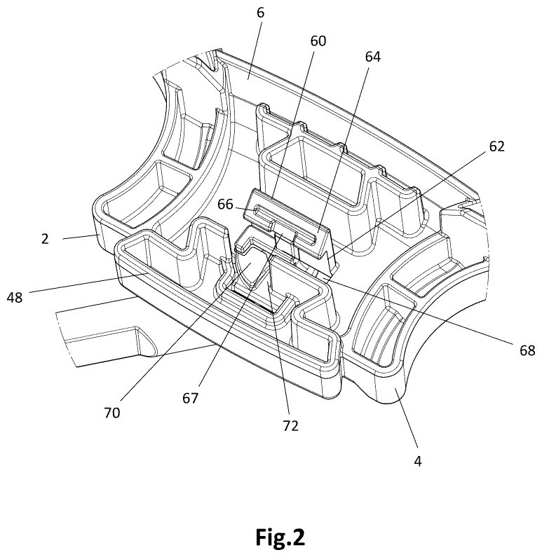

A locking member 60 is located between the first and second locating element 46,48. As shown in FIG. 2, the locking member 60 consists of an arrowhead locking tab comprising an upstanding wall 62 extending from inner surface 32 and arranged lengthwise along the bridge section, perpendicular to the insertion axis A-A. A tapered, wedge-shaped locking head 64 is located at the distal end of the wall 62 and slopes outwardly and downwardly from the distal end. The locking head 64 includes a lower locking surface 65 arranged perpendicular to the wall 62. The wall has a height H1 level with the upper edge 40 of the peripheral walls of the coupler 1a, and the locking head is arranged above the wall 62, with the lower locking surface 65 arranged at the height H1 level with the upper end of the wall 62. A laterally extending channel 66 and a stepped rectangular recess 67 are formed in the forward edge of the upper surface. The rectangular recess 67 is formed having a length that is greater than its depth in the insertion axis. A key slot 68 is formed in the base 31 on the front side of the locking member 60. The key slot 68 is arranged immediately beneath the locking head 64. A ramped guide surface 70 is located adjacent the forward edge of the key slot 68. An opening 72 is formed in the rear part of the second locating element 48. The opening 72 is aligned with the recess 67 of the locking member 60 and partially receives the guide surface 70, part of which extends into the locating element 48.

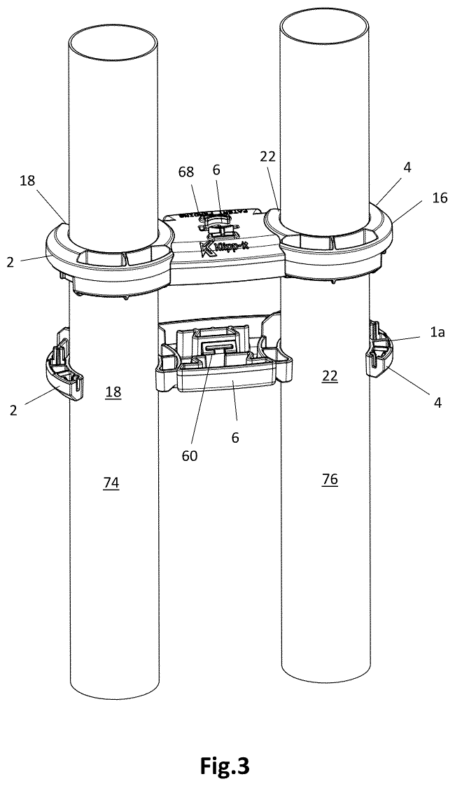

Referring to FIG. 3, the fence panel couplers 1a, 1b are used in pairs to secure adjacent fence panels having respective first and second fence posts 74, 76. The fence posts 74, 76 are arranged in parallel and each has a length having a longitudinal axis. The longitudinal axis of each post is typically arranged vertically, and reference herein to movement in the vertical axis is a relative term meaning movement along the longitudinal axis of the posts 74, 76. The first coupler 1a and second coupler 1b are arranged with the first coupler 1a located on a first side of the fence posts 74, 76 and the second coupler 1b located on the other side of the fence posts 74, 76. In a first assembly stage the first coupler 1a is arranged to align the first and second connector portions 2, 4 with the fence posts 74, 76 respectively, with the forward edge of the first coupler 1a facing the posts 74, 76. The outer surface 33 of the first coupler 1a is downwardly facing, and the inner surface 32 faces upwardly. The first coupler 1a is moved into engagement with the posts 74, 76 in the first insertion direction A. The first connector portion 2 is inserted onto the respective post 74 by forcing the opening 18 of the connector portion 2 against the post 74 in the insertion direction A. The diameter of the post 74 corresponds to the diameter of void 16 within the first connector portion 2. Initially, with the connector portion 2 in a neutral, contracted configuration the opening 18 is narrower than the diameter of the post 74, and the connector portion 2 therefore does not readily insert onto the post 74.

The continued application of pressure in the insertion direction A causes the resiliently flexible arm 14 to begin to flex outwardly to an expanded configuration, which expands the opening 18 to receive the post 74. When the post 74 is received within the connector portion 2 the resilient arm 14 returns to the contracted configuration and grips against the post 74. The connector portion 2 is formed to have a close tolerance fit, or even an interference fit with the post, such that the flexible arm 74 remains in a close, biased clamping engagement with the post 74. The thickness of the flexible arm 14 and the material of the couplers 1a, 1b are selected to ensure that the couplers 1a, 1b may be manually pressed onto the posts 74, 76 without requiring excessive force and without the need for a tool. When the first connector portion 2 has been inserted onto the first post 74, the second connector portion 4 is inserted onto the second post 76 in the same manner as the first connector portion. Once the first connector portion is inserted onto the first post the coupler 1a may be rotated about the first port 74 to move the second connector portion 2 into engagement with the second post 76. It will be appreciated that the above order of assembly is not essential and the second connector portion 4 could be applied first, or the first and second connector portions 2, 4 may be pressed into engagement and inserted onto the posts 74, 76 simultaneously.

When the first and second connector portions 2, 4 have been clipped into position on the posts 74, 76 they are securely connected to the posts 74, 76 in a self-supporting manner and may be released without becoming detached from the post. At this stage, the fence panels are connected and coupled by the first coupler 1a. However, the first coupler 1a may be readily removed from the fence posts 74, 76 be pulling it away from the posts 74, 76 in a reverse of the above process.

In a second assembly stage, the second coupler 1b is moved into engagement with the fence posts 74, 76 from the opposing side. The second coupler 1b is arranged above the first coupler 1a and in the reverse orientation, with the outer surface 33 facing upwardly and the inner surface 32 facing downwardly towards the first coupler 1a. Inner surfaces 33 of the first and second couplers 1a, 1b are therefore facing towards each other. The second coupler 1b is brought to engagement with the fence posts 74, 76 at a position vertically spaced above the first coupler 1a. The second coupler 1b is connected to the fence posts 74,76 in the same manner as the first coupler 1a, with the connector portions 2,4 being expanded through flexing of the resilient arms 14,22 to expand the openings 18,24 and enable the connector portions 2,4 to be clipped onto the posts 74,76 in a push fit arrangement.

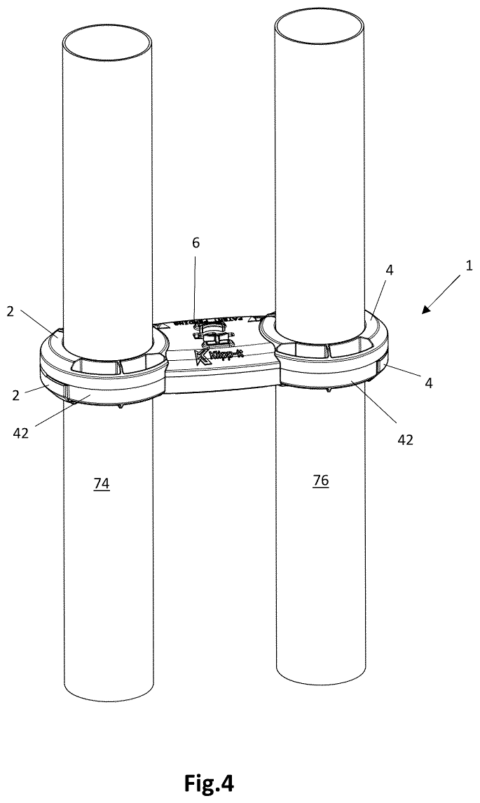

When the second connector 1b is secured to the posts 74, 76 the first and second couplers 1a, 1b are brought together by vertically sliding one or both couplers 1a, 1b towards each other along the posts 74, 76. As the couplers 1a, 1b are brought together into a coupling assembly the locking members 60 of the respective couplers 1a, 1b are aligned and come into engagement with each other causing the couplers to vertically lock together, as shown in FIG. 4. In this arrangement, the closure members 42 of the first coupler 1a align with and are received within the openings 18, 24 of the second coupler 1b and the closure members 42 of the second coupler 1b align with and are received within the openings 18, 24 of the first coupler 1a. In this way, the openings 18, 22 of each coupler are closed and the connector portions 2, 4 of each coupler 1a, 1b cooperate to form ring shaped connectors that completely surround the fence posts 74, 74 in a handcuff configuration. In this configuration, with the openings 18, 22 closed and the posts 74, 76 encircled by the coupling assembly, it is not possible to pull the coupling assembly 1 off the posts 74, 76 in either direction.

Separation of the couplers 1a, 1b along the insertion axis is prevented by the interlocking dovetail arrangement of the first and second locating elements 46, 48. The first locating element 46 of the first coupler 1a aligns with and is received within the enclosure of the second locating element 48 of the second coupler 1b as the couplers 1a, 1b are brought together vertically. Similarly, the first locating element 46 of the second coupler 1b aligns with and is received within the corresponding second locating element 48 of the first coupler 1a. The interlocking dovetail arrangement of the respective first and second locating element 46,48 pairings both aligns the couplers 1a,1b with each other and prevents separation of the couplers 1a,1b in either direction along the insertion axis A-A away from the posts 74,76. Simultaneously, the locating tabs 49 of the first coupler 1a are received within the corresponding slots 49 of the at the distal ends of the flexible arms 14, 22 of the second coupler 1b, and the locating tabs 49 of the second coupler 1b are received within the corresponding slots 49 of the at the distal ends of the flexible arms 14, 22 of the first coupler 1a. The locating tabs 49 locate and laterally restrain the distal ends of the flexible arms 14,22, preventing any outward flexing of the flexible arms 14,22 that might expand the openings 18,24, such that the connection portions 2,4 of the first and second couplers 1a,1b form rigid rings around the fence pots 74,76.

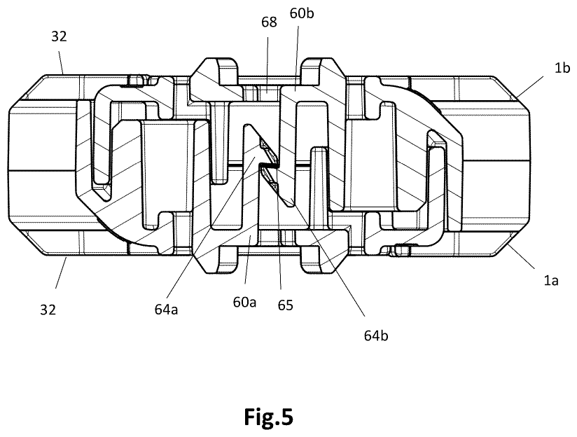

As shown in FIG. 5, the couplers 1a, 1b are arranged such the locking member 60a of the first coupler 1a and the locking member 60b of the second locking member 1b are aligned and extend towards each other. Each locking head 64a, 64b is wedge shaped and includes a sloping lead surface 80a, 80b respectively. As the couplers 1a,1b are brought together the lead surfaces 80a,80b engage and the ramped wedging action of the two locking heads 64a,64b as the two locking members 60a,60b continue to move towards each other causes the locking members 60a,60b to flex away from each other along the insertion axis A-A. The locking members 60a, 60b are resilient and are biased to the normal upright position. When the locking heads 64a, 64b reach a position where they pass each other, each return to the original upright position. The lower locking surfaces 65a,65b abut each other and create a mechanical interlock preventing vertical separation of the locking members 60a,60b thereby locking the couplers 1a, 1b together to create a coupler assembly. The uppermost second coupler 1b covers and closes the inner structure of the first coupler 1a and vice versa. The locking members 64 are therefore enclosed and encapsulated within the coupler assembly and cannot be accessed once the coupler assembly is locked. The posts are completely encompassed by the connection portions when the couplers 1a, 1b are assembled and the locking members 60a, 60b cannot be accessed to separate the couples 1a, 1b, thereby preventing unauthorised removal of the coupler assembly.

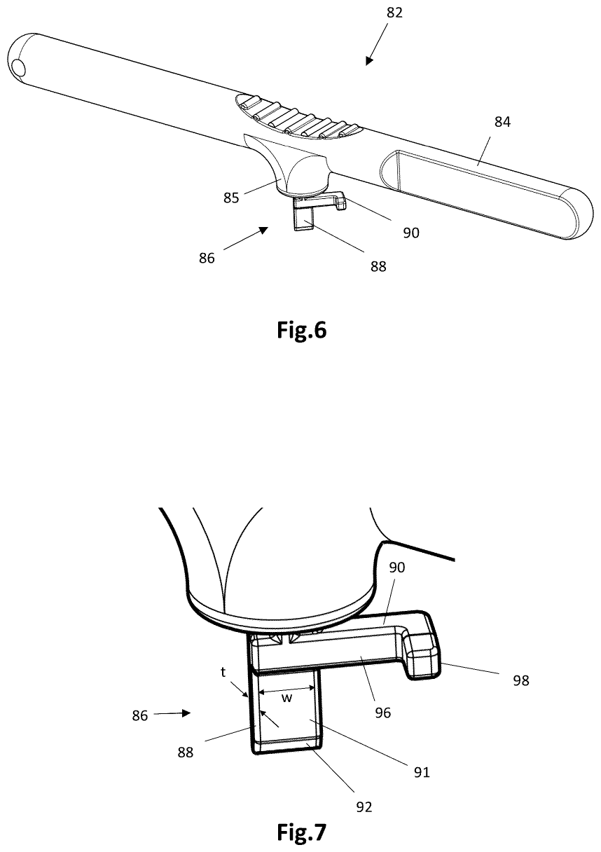

Referring to FIG. 6, a removal tool 82 is provided to separate and remove the coupler assembly. The removal tool 82 comprises an elongate handle 84, with a cylindrical barrel 85 and a key 86 projecting from the centre of the handle 84. The key 86 comprises a stem 88 extending from the barrel 85 in a direction perpendicular to the longitudinal axis of the handle 84. A locking tab 90 projects perpendicularly from the stem 88 in a direction parallel with the longitudinal axis of the handle 84. As shown in FIG. 7 the stem 88 has a rectangular cross section with a width w and thickness t, with the width w being greater than the depth t. The stem 88 has a front face 91 and chamfered lower edge 92 tapering inwardly from the front face 92 in the direction of the distal end of the stem 88. The locking tab 94 is L-shaped having a shaft 96 that extends width wise away from the stem 88, and a finger 98 located at the distal end of the shaft 96 and extending forwardly from the shaft 96 in a perpendicular direction relative to the front face of the stem 88.

Referring to FIG. 1, the key slot 68 is L-shaped and configured to receive the key 86. The L-shaped key slot 68 is ensure the key is can only be inserted in a single orientation. The key slot 68 is arranged such that the stem 88 of the key 86 is aligned with the recess 67 laterally and in the insertion direction. Semi-circular guides 93 project from the outer surface 32 of each coupler 1a,1b that are configured to receive and locate the barrel section 85 of the handle 84 to ensure correct alignment of the key 86. The width w of the stem 88 corresponds to the width of the recesses 67 of the locking members 60a, 60b. The key 86 is inserted vertically into the key slot 68. The width w of the stem 88 is oriented parallel to the locking member 60b of the uppermost second coupler 1b. The distal end of the key 86 is received within the recess 67 of the locking member 60a of the first coupler 1a. The chamfered lower edge 92 engages with the sloping inner surface of the recess 67 creating a lateral reaction force that causes initial outward flexing of the first locking member 60a away from the second locking member 60b as the stem 88 of the key 86 locates between the locking head 64a of the first locking member 60a and the wall 62b of the second locking member 60b in a first unlocking position. In this first unlocking position the stem 88 spaces the locking head 64a of the first locking member 60 from the second locking member 60b by a distance corresponding to the thickness t of the stem 88. The locking tab 90 remains aligned with the key slot 68.

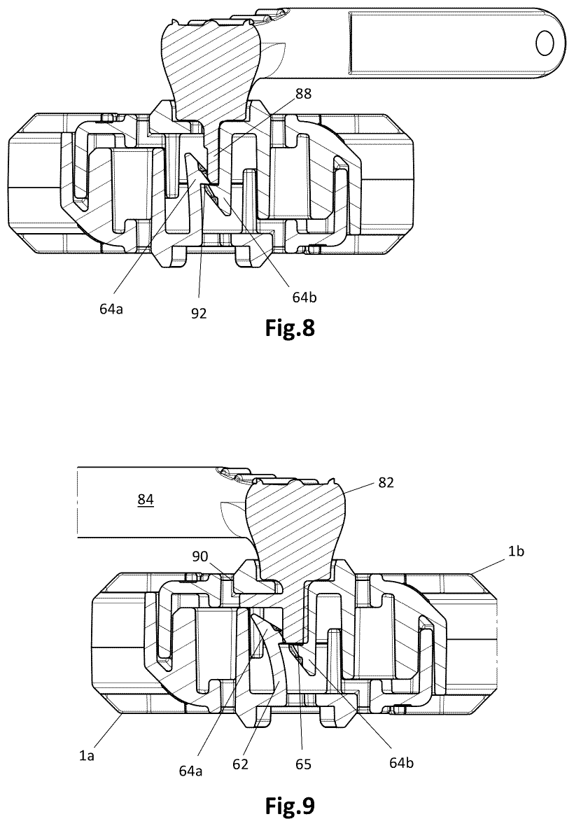

As shown in FIGS. 8 and 9, the handle 84 is rotated 90 degrees to rotate the key 86 to the second unlocking position. In this position, the stem 88 spaces the locking head 64a of the first locking member 60 from the second locking member 60b by a distance corresponding to the width w of the stem 88, which is greater than the thickness t. This causes the first locking member 60a to flex further away from the second locking member 60b. The width w is selected such that in the second unlocking position the locking heads 64a, 64b are separated and able to move vertically past each other. As shown in FIG. 2, the ramped guide surface 70 is arranged adjacent the key slot 68. The guide surface has a curved form corresponding to the arc of rotation of the locking tab 90 and increases in height from a first end adjacent the key slot 68 to the opposing second end. As the key 86 is rotated between the first unlocking position and the second unlocking position the locking tab 90 travels across the surface of the ramped guide surface 70 from the first end to the second end. This moves the stem 88 axially further into the coupler assembly and causes the stem 88 to apply an axial force to the locking member 60 of the opposing coupler in addition to the lateral separation force applied between the locking members 60a, 60b. This force is sufficient to move the locking surfaces 67a, 67b axially past each other to release the interlock, and create initial separation of the couplers 1a, 1b in the closure axis.

In the second locking position the locking tab 90 is rotated to a position where it is misaligned with the key slot 68. Referring again to FIG. 9, the locking tab 90 engages the inner surface of the second coupler 1b. In this position the key 86 cannot be retracted from the key slot 68 without rotation. Lifting the removal tool 82 upwards by the handle 84 causes the locking tab 90 to lift the second coupler 1b to separate the couplers 1a, 1b. The removal tool 82 is bespoke having a configuration tailored to the specific geometry. A recess is arranged at the second end of the ramped guide surface to locate the locking tab when it has been rotated 90 degrees and travelled past the end of the ramp, to hold the locking tab 90 in the second release configuration while the handle is used to lift the coupler.

The first and second couplers 1a, are identical and both include key slots 68. Therefore, a single universal component is supplied to an erection site, and pairs of the same universal component i.e. pairs of couplers 1 are provided at each coupling location. The couplers 1 can be applied in any order, and each can be oriented to be the upper coupler 1b or the lower coupler 1a. The couplers 1 can be applied individually and are self-supporting once inserted onto the fence posts, meaning a person does not have to hold the first coupler 1a while acquiring and applying the second coupler 1b. Furthermore, the couplers 1a, 1b can be easily applied by hand and only require a single person to do so. The couplers 1 therefore significantly simplify assembly, are lightweight and cost effective, quick to apply and reduce the necessary labour. Furthermore, the coupler assembly cannot be removed without a bespoke tool and is therefore significantly more secure than couplers of the prior art without requiring any additional fixings, locks or ties.

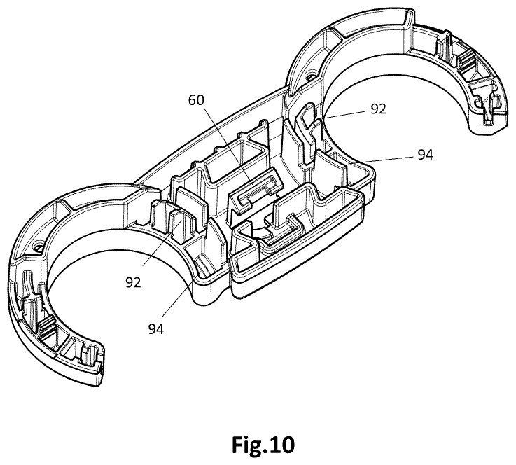

In a further embodiment, as shown in FIG. 10, the connector portions 1a, 1b include interference members 92 arranged to limit flexing of the coupler 1 along the longitudinal axis. The interference members 92 include upstanding walls 94 extending vertically from the upper edge 40 of the first and second coupling portions 2, 4. The walls 94 are arranged on the connector portions 2, 4 between the inner and outer walls adjacent the bridge 6. The walls 94 each include a circumferential wall section and radially extending ribs. A recess 96 is formed in each connector portion 2, 4 adjacent the wall 94, that is configured to receive a corresponding interference member 92 of the other coupling member 1b. Further interference members may be located at other circumferential positions around the connector portions 2, 4. The interference members 92 and recesses 96 are configured such that the interference member 92 is vertically received into the recess 96 in a close fit. The interference member 92 is axially aligned with the recess, with the walls and ribs being parallel with the inner walls of the recess 94. If the coupling members 1a, 1b are prised apart at their ends while they are connected at the bridge by the connector 60, the ends flex relative to the bridge 6. This causes axial misalignment between the interference member 92 and the recess 94. The interference member 92 is angled into contact with the inner walls of the recess 94 and the mechanical interference and frictional engagement between the two parts prohibits or limits vertical separation of the ends of the coupling members 1a, 1b, and limits separation and flexing forces being applied to the connector 60.

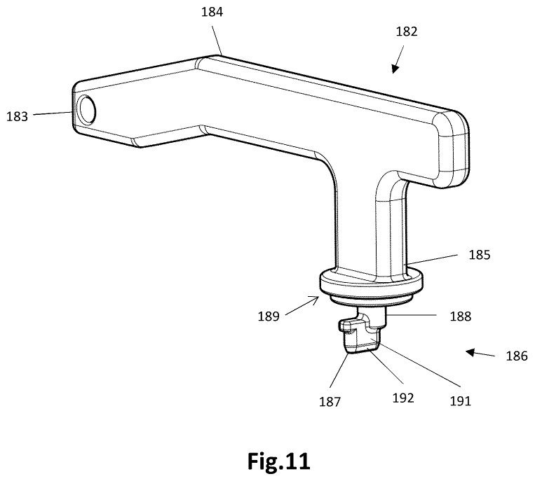

Referring to FIGS. 11-13, a removal tool 182 is provided to separate the coupling members 100a, 100b and remove the coupler assembly 101 from a fence. The removal tool 182 comprises an elongate handle 184 and a key 186 projecting from the handle 184. The key 186 comprises a stem 188 extending from the handle 184 in a direction substantially perpendicular to a longitudinal axis of the handle 184. A wedging element 187 extends from the stem 188. The wedging element 187 has a width and a depth; wherein the width is greater than the depth. The stem 188 has a front face 191 and chamfered lower edge 192 tapering inwardly from the front face 191 towards a distal end of the stem 188.

The handle 184 is substantially L-shaped comprising a distal end 183 configured to be gripped by a user, and a proximal end 185 which is connected to the key 186. Such a shape spaces the distal end 183 of the handle 184 away from the key 186 to provide space for a user's hand on the handle 184, and to provide a moment arm such that rotating the key 186 may be easy. An axis of the removal tool 182 is disposed at a proximal end 185 of the handle 184. In this way, the handle 184 may be limited, in use, to one side of a fence panel. This may be convenient for a user installing or removing the fence panel coupler as they may not need to pass any part of the handle 184 through the fence. Further, the handle 184 is compact and lightweight.

The removal tool 182 comprises a stepped interface portion 189. The stepped interface portion 189 is configured to engage with a rib structure 169 arranged around the aperture 168 of a coupling member 100a. By providing such engagement, the removal tool 182 may be securely seated against the coupling member 100a when the key 186 is in the aperture 168. This may reduce a risk of the key 186 becoming damaged through stress applied to the handle 184 being transferred to the coupling member 100a by the key 186. The stepped interface portion 189 provides an alternative path for stress to be transferred from the handle 184 to the coupling member 100a. In particular, stress applied in directions other than rotation about a rotation axis of the removal tool 182 may risk damaging the fine features of the key 186. Such stress may be applied by pressing downwards or pulling upwards on the handle 184 when the key 186 is inserted in the aperture 168 or rotating the removal tool 182 about the longitudinal axis of the elongate handle 184.

In use, the wedging element 187 is configured to be rotated by the user operating the removal tool 182 after the key 186 is inserted in the aperture 168 of a coupling member 100a. On insertion into the aperture 168, the wedging element 187 is disposed between integral connectors 60a, 60b of the coupling members 100a, 100b such that a depth of the wedging element 187 is arranged between the integral connectors 60a, 60b of the coupling members 100a, 100b. On being rotated by the user operating the removal tool 182, the wedging element 187 is disposed between the integral connectors 60a, 60b of the coupling members 100a, 100b such that a width of the wedging element 187 is arranged between the integral connectors 60a, 60b of the coupling members. The width of the wedging element 187 being greater than the depth of the wedging element 187, after rotation, the wedging element 187 occupies a greater distance between the integral connectors 60a, 60b of the coupling members 100a, 100b. Provided that, when the fence panel coupler is in the closed configuration, the integral connectors 60a, 60b are arranged at a distance from one another than is greater than a depth, but less than a width, of the wedging element 187, when the key 186 is inserted through the aperture 168 and rotated, at least one of the integral connectors 60a, 60b may be flexed, i.e. bent, to accommodate the width of the wedging element 187. The removal tool 182 and the integral connectors 60a, 60b of the fence panel coupler assembly 101 are configured to co-operate such that, when an integral connector 60a or 60b of a coupling element 100a or 100b is bent by the wedging element 187, the first and second coupling members 100a, 100b may disengage from one another.

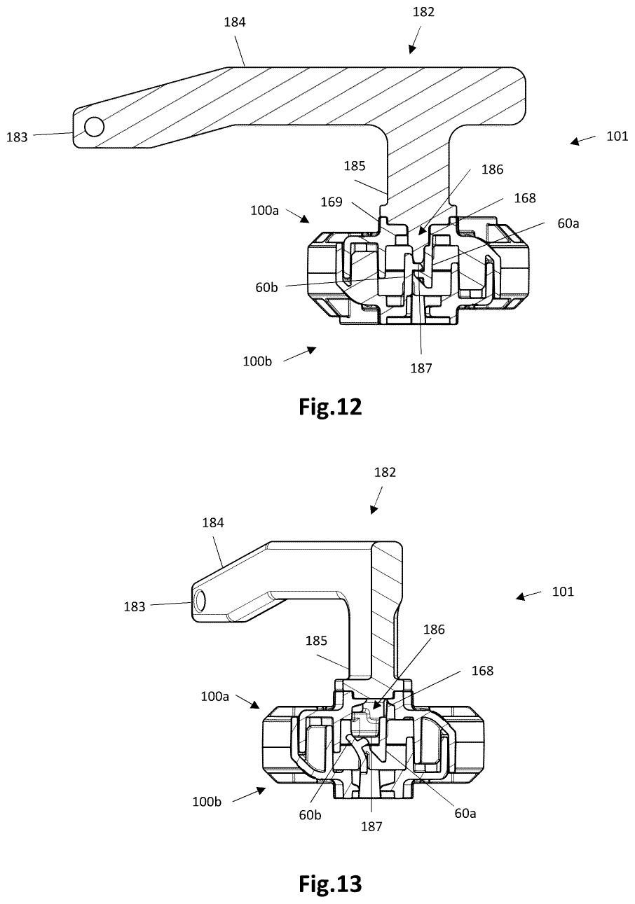

FIG. 12 shows the fence panel coupler assembly 101 with the removal tool 182 in a first orientation. In use, the key 186 of the removal tool 182 is inserted into the aperture 168 of a coupling member 100a of a fence panel coupler assembly 101 as shown in FIG. 12. The aperture 168 is sized so that the key 186 may only be inserted into the aperture 168 when the removal tool 182 is in the first orientation. When in the first orientation, the removal tool 182 is orientated such that the handle 184 is arranged substantially perpendicular to a longitudinal axis of the fence panel coupler 101a. When the fence panels are parallel and adjacent so that the fence is substantially straight, the handle 184 may be arranged substantially perpendicular to the fence when the removal tool 182 is in the first orientation.

To uncouple the first and second coupling members 100a, 100b of the fence panel coupler assembly 101 to release the fence panel coupler assembly 101 and disconnect the first and second fence panels, the removal tool 182 is rotated through an acute angle to the second orientation. As, in use, the fence panel coupler assembly 101, is located between fence posts, a 90° rotation of the handle 184 of the removal tool 182 may not be possible or easy. On the other hand, a small rotation angle may not provide adequate leverage to enable the wedging element 187 to bend the integral connector 60a or 60b of one of the coupling members 100a, 100b to disengage the integral connectors 60a, 60b and decouple the coupling members 100a, 100b. Accordingly, the acute angle may be approximately 45°, or greater. FIG. 13 shows a cross section of the fence panel coupler assembly 101 with the removal tool 182 in a second orientation. The first coupling member 100a receives the key 186 of the removal tool 182 through the aperture 168, or key slot, of the coupling member 100a. The wedging element 187 of the key 186 of the removal tool 182 interacts with the integral connectors 60a, 60b of the coupling members 100a, 100b. In particular, the wedging element 187 of the key 186 of the removal tool 182 forces the integral connector 60b of the second coupling member 100b to bend away from the key 186, and therefore away from the integral connector 60a of the first coupling member 100a. Accordingly, when the removal tool 182 is in the second orientation, the first and second coupling members 60a, 60b are not interlocked and may be disconnected such that they do not occupy the closed configuration. In this way, the removal tool 182 unlocks the coupling members 100a, 100b.

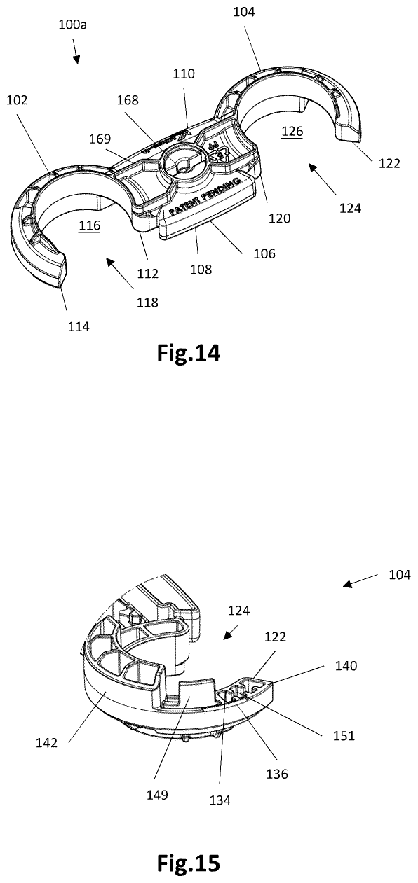

Referring to FIG. 14, a coupling member 100a comprises a first connector portion 102, a second connector portion 104, and a bridge section 106. The bridge section 106 is disposed between the first and second connector portions 102, 104 to connect the first and second connector portions 102, 104. The first connector portion 102 is integrally formed with and connected to a first side of the bridge section 106. The second connector portion 104 is integrally formed with and connected to a second side of the bridge section 106.

The coupling member 100a has a forward edge 108 and a rear edge 110. The first connector portion 102 is substantially C-shaped having a first end 112 connected to and integrally formed with the bridge section 106 and a second end 114 defining a curved flexible arm projecting from the bridge section 106. The C-shaped body of the first connector 102 defines a circular inner void 116. An opening 118 to the C-shaped first connector portion 102 is defined at the front edge 108 of the first connector portion 102 and defines the opening to the void 116. A second end 114 of the first connector 102 is configured to flex outwardly away from the first end 112 of the connector 102 to expand the opening 118. The second end 114 is resilient and biased to return to its original configuration when any flexing force is removed.

The second connector portion 104 is located on the opposing side of the bridge section 106 from the first connector portion 102 and has the same configuration as the first connector portion 102 in a mirrored arrangement. The second connector portion 104 has a first end 120 connected to and integrally formed with the bridge 106 and a resiliently flexible second end 122. The second connector portion 104 is also C-shaped and has an opening 124 defined between the first and second ends 120, 122. The opening 124 allows access to the inner void 126 defined within the C-shaped second connector portion 104. The first and second connector portions 102, 104 are the same size, each being configured to receive a fence post having circular cross section.

The bridge section 106 includes a key slot 168. The key slot is configured to receive the key 186. The key slot 168 is surrounded by a rib structure 169 that is configured to increase a stiffness of the bridge section 106 and the key slot 168. The rib structure comprises a circular rib, and four further ribs that connect the central circular rib with the connector portions 102, 104. The rib structure 169 is formed integrally with an outer surface of the coupling element 100a. By providing the rib structure 169, a stiffness of the coupling member 100a about a longitudinal axis of the coupling member 100a may be increased. That is to say, the torsional stress required to achieve a given strain about the longitudinal axis of the coupling member 100a may be increased by the introduction of the rib structure 169.

Referring to FIG. 15, an enlarged underside view of a second connector portion 104 of the coupling member 100a of FIG. 14 is shown. A first connector portion 102 of the coupling member 100a may be a mirror image of the second connector portion 104 such that the coupling member is symmetrical about an axis perpendicular to the longitudinal axis of the coupling member 100a. Accordingly, features and advantages of the second connector portion 104 described below may apply in a mirrored arrangement to the first connector portion 102.

The connector portion 104 comprises a curved closure element 142 that is located at a rear edge of the second connector portion 104 and is located diametrically opposite the opening 124. The closure element 142 has a total height that is substantially double the height of the second end 122 of the second connector portion 104. The angular extent of the closure element 142 is equal to the angular extent of the opening 124 with the opening 124 and the closure element 142 each extending approximately 90° around the second connector portion 104. The closure element 142 is hollow and open at its upper end for light weighting. The closure element 142 includes drainage apertures in a base to prevent it filling with rainwater in use.

An upstanding locating tab 149 projects from the upper edge 140 of a second end 122 of the connector portion 104. The locating tab 149 is centrally located between the inner and outer walls 134, 136 and is vertically stepped below the height of the closure element 142. A corresponding locating tab (not shown) is disposed on the second end 114 of the first connector portion 102. A slot 151 is provided on the second end 122 of the second connector portion 104 between a distal end of the second end 122 and the locating tab 149. The slot is centrally located between the inner and outer walls 134, 136. A corresponding slot (not shown) is disposed on the second end 114 of the first connector portion 102, between a distal end of the second end 114 and the corresponding locating tab (not shown).

The first and second coupling members 100a, 100b being substantially identical, the locating tabs 149 and slots 151 of the first coupling member 100a are configured to interlock with those of the second coupling member 100b when the fence panel coupler assembly 101 is in the closed position to further secure the first and second coupling members 100a, 100b together. In particular, the interlocking of locating tabs 149 and slots 151 provides further torsional rigidity and shear strength. The locating tab 149 and corresponding locating tab, disposed respectively on second and first connector portions 104, 102 of the first coupling member 100a, are configured to co-operate with the slot 151 and corresponding slot disposed respectively on second and first connector portions 104, 102 of the second coupling member 100b. Further, the locating tab 149 and corresponding locating tab, disposed respectively on second and first connector portions 104, 102 of the second coupling member 100b, are configured to co-operate with the slot 151 and corresponding slot disposed respectively on second and first connector portions 104, 102 of the first coupling member 100a.

1. A fence panel coupler comprising:
a first coupling member including first and second connector portions each having an opening for receiving respectively one of a first fence post and a second fence post; and
a second coupling member including third and fourth connector portions each having an opening for receiving a respective one of the first and second fence posts;
wherein the first and second coupling members are movable together to a closed configuration and include integral connectors that connect the first and second coupling members together in the closed configuration.

2. A fence panel coupler according to claim 1, wherein the integral connectors comprise integral locking elements that lock the first and second coupling members together in the closed configuration.

3. A fence panel coupler according to claim 1, wherein the connector portions each include a resiliently flexible element reconfigurable to an expanded configuration to enlarge the respective opening of the connector portion for receiving the respective fence post.

4. A fence panel coupler according to claim 1, wherein:
the openings of the first and second connector portions are arranged for receiving respectively the first and second fence posts when the first coupling member is applied to the fence posts in a first insertion direction;
the openings of the third and fourth connector portions are arranged for receiving respectively the first and second fence posts when the second coupling member is applied to an opposing side of the fence posts in a second insertion direction that is opposite to the first insertion direction; and
wherein the locking elements are arranged to interlock when the first and second coupling members are moved into engagement in a direction perpendicular to the first and second insertion directions.

5. A fence panel coupler according to claim 4, wherein the connector portions of the first and second coupling members are c-shaped having opposing ends between which the opening is defined and the flexible element of each connector portion comprises a flexible arm formed by a free end of the respective c-shaped connector portion.

6. A fence panel coupler according to claim 5, wherein the c-shaped connectors are configured to connect to the fence posts in a snap fit arrangement.

7. A fence panel coupler according to claim 3, wherein the coupling members are configured to slide along the fence posts when the fence posts are received within the connector portions of the coupling members, and in use the first and second coupling members slide towards each other along the fence posts to the closed configuration.

8. A fence panel coupler according to claim 5, wherein the flexible arm of each connector portion is reconfigurable between a clamping configuration in which the opening has a first width and the expanded configuration in which the opening has a second width and is biased to the clamping configuration.

9. A fence panel coupler according to claim 8, wherein the flexible arm of each connector portion moves to the expanded configuration when the opening of the connector portion is urged against a fence post.

10. A fence panel coupler according to claim 1, wherein the first and second connector portions of the first coupling member are interconnected by a first bridge section, and the third and fourth connector portions of the second coupling member are interconnected by a second bridge section, and wherein the interlocking elements of the first and second coupling members are located on the first and second bridge sections respectively.

11. A fence panel coupler according to claim 1, wherein the first coupling member includes first and second closure elements and the second coupling member includes third and fourth closure elements, the first and second closure elements being arranged to close the openings of the third and fourth coupling portions and the third and fourth closure elements are arranged to close the openings of the first and second connector portions when the first and second coupling members are connected in the closed configuration.

12. A fence panel coupler according to claim 11, wherein the first and second closure members are integral parts of the first and second connector portions and the third and fourth closure members integral parts of the third and fourth connector portions, and in the closed configuration the first and third connector portions combine to form a first annular connector that in use surrounds the first fence post and the second and fourth connector portions combine to form a second annular connector that in use surrounds the second fence post.

13. A fence panel coupler according to claim 1, wherein the locking elements each extend from an inner surface of the respective coupling members and each comprises a flexible shaft and a tapered locking head, and wherein when the coupling members are moved to the closed configuration the locking elements flex away from each other when the locking heads engage and close to an interlocked configuration when the locking heads move past each other.

14. A fence panel coupler according to claim 1, wherein the first and second coupling members are configured to be moved to the closed configuration along a closure axis that in use is parallel with the longitudinal axis of the fence posts, and the coupling members are configured to be inserted onto the fence posts along an insertion axis that is perpendicular to the closure axis, and the locking elements interlock to prevent separation along the closure axis.

15. A fence panel coupler according to claim 14, wherein the first and second couplers include secondary interlocking elements that interlock when the coupling members are in the closed configuration and are arranged to prevent separation along the insertion axis.

16. A fence panel coupler according to claim 1, wherein the integral locking elements are enclosed within the fence panel coupler in the closed configuration, and at least one of the coupling members includes an aperture arranged for receiving a tool to release the locking elements and enable separation of the coupling members.

17. A fence panel coupling system comprising a fence panel coupler according to claim 16 and a release tool configured to be inserted into the aperture of the coupling member, wherein the locking elements are arranged relative to the aperture such that they are engaged by the release tool on insertion, which causes the locking elements to separate.

18. A fence panel coupling system according to claim 17, wherein the release tool include a stem having a longitudinal axis and first and second lateral dimensions perpendicular to the longitudinal axis, the second lateral dimension being greater than the first lateral dimension, the stem being inserted in a first orientation in which the locking elements are separated by the first lateral dimension and the stem being rotatable to a second orientation in which the locking elements are separated by the second lateral dimension.

19. A fence panel coupling system according to claim 18, wherein the stem includes a locking tab that is received through the aperture when the stem is in the first orientation and engage with one of the coupling members to prevent release of the stem from the aperture when the stem is in the second orientation, enabling the release tool to lift the coupling member to separate the fence coupler.

20. A fence panel coupling system according to claim 19, wherein the coupling member comprising said aperture includes a ramped surface arranged to be engaged by the locking tab when the stem is moved to the second orientation, and engagement of the locking tab with the ramped surface causes the stem to move axially into further axial engagement with the coupler to cause axial separation of the locking elements.

21. A method of coupling fence panels, comprising:
providing a fence coupler according to claim 1;
connecting the first fence coupling member onto a first side of first and second fence posts in a first insertion direction;
connecting the second fence coupling member onto a second side of the first and second fence posts in an opposing second insertion direction at a spaced location relative to the length of the fence posts; and
moving the first and second coupling members to a closed configuration by sliding at least one of the coupling members into engagement with the other along the first and second fence posts.
